(19) United States
(12) Patent Application Publication
(10) Pub. No.: US 2006/0061292 A1
(43) Pub. Date: Mar. 23, 2006

(54) Display device and driving method thereof

(75) Inventors: Byung-Sik Koh, Gwangmyeong-si (KR); Joon-Chul Goh, Seoul (KR); Nam-Deog Kim, Yongin-si (KR); Chun-Seok Ko, Hwasung-si (KR); Beohm-Rock Choi, Seoul (KR)

Correspondence Address: MCGUIREWOODS, LLP, 1750 TYSONS BLVD, SUITE 1800, MCLEAN, VA, 22102, US

(73) Assignee: Samsung Electronics Co., Ltd.

(21) Appl. No.: 11/227,098

(22) Filed: Sep. 16, 2005

(30) Foreign Application Priority Data
Sep. 17, 2004 (KR) 10-2004-0074592
May 23, 2005 (KR) 10-2005-0042915

(51) Int. Cl. G09G 3/10

(52) U.S. Cl. 315/169.3

(57) ABSTRACT

A display device is provided, which includes: a plurality of pixels, each pixel including a light emitting element; a signal controller modifying the input image signals based on an accumulated time of driving the light emitting elements; and a data driver generating data signals based on the modified image signals and supplying the data signals to the pixels.

### CROSS REFERENCE TO RELATED APPLICATION

This application claims priority to and the benefit of Korean Patent Application No. 10-2004-0074592, filed on Sep. 17, 2004 and No. 10-2005-0042915, filed on May 23, 2005, which are hereby incorporated by reference for all purposes as if fully set forth herein.

### BACKGROUND OF THE INVENTION

1. Field of the Invention

The present invention relates to a display device and a driving method thereof, and in particular, a light emitting display device and a driving method thereof.

2. Discussion of the Background

Light-weight and thin personal computers and televisions sets require light-weight and thin display devices, and flat panel displays satisfying this requirement are being substituted for conventional cathode ray tubes (CRT).

Flat panel displays used for this purpose include liquid crystal display (LCD), field emission display (FED), organic light emitting diode (OLED) display, plasma display panel (PDP), and so on.

Generally, an active matrix flat panel display includes a plurality of pixels arranged in a matrix and displays images by controlling the luminance of the pixels based on given luminance information. An OLED display is a self-emissive display device that displays images by electrically exciting light emitting organic material, and it has low power consumption, a wide viewing angle, and fast response time, thereby being advantageous for displaying moving images.

A pixel of an OLED display includes an OLED and a driving thin film transistor (TFT). The OLED emits light having an intensity that depends on the current driven by the driving TFT, which in turn depends on the threshold voltage of the driving TFT and the voltage between the gate and the source of the driving TFT.

A TFT may include polysilicon or amorphous silicon. A polysilicon TFT has several advantages, but it also has disadvantages such as the complexity of manufacturing polysilicon, thereby increasing the manufacturing cost. In addition, it is hard to make a large OLED display employing polysilicon.

On the contrary, an amorphous silicon TFT is easily applicable to a large OLED display and manufactured by fewer process steps than the polysilicon TFT requires. However, the threshold voltage of the amorphous silicon TFT shifts over time, due to an extended application of a unidirectional voltage to a gate of the TFT. This results in non-uniform current flowing in the OLED, degraded image quality and a shortened lifetime of the OLED.

Accordingly, several pixel circuits for compensating the shift of the threshold voltage have been suggested. However, since most of the suggested pixel circuits have several TFTs and capacitors as well as several signal lines, the suggested pixel circuits may cause a reduced aperture ratio and complicate the design.

In addition, since OLEDs emitting different color lights have different lifetimes and different efficiencies, the OLEDs representing different colors may show different luminance for the same gray voltage.

### SUMMARY OF THE INVENTION

This invention provides a solution to the problems of conventional techniques.

Additional features of the invention will be set forth in the description which follows, and in part will be apparent from the description, or may be learned by practice of the invention.

The present invention discloses a display device that includes: a plurality of pixels, each pixel including a light emitting element; a signal controller modifying the input image signals based on an accumulated time of driving the light emitting elements; and a data driver generating data signals based on the modified image signals and supplying the data signals to the pixels.

The present invention also discloses a method of driving a display device including light emitting elements that includes: accumulating emission time of the light emitting elements; obtaining modification data for input image signals based on the accumulated emission time; modifying the input image signals based on the modification data; and making the light emitting elements emit light based on the modified image signals.

The present invention also discloses a display device that includes: a plurality of pixels, each pixel including a light emitting element; a signal controller generating digital gamma data based on an accumulated time of driving the light emitting elements; a gray voltage generator generating at least one set of gray voltages corresponding to the digital gamma data supplied from the gamma data generator; and a data driver generating data voltages corresponding to input image signals based on the at least one set of gray voltages supplied from the gray voltage generator and supplying the data signals to the pixels.

The present invention also discloses a method of driving a display device including light emitting elements that includes: accumulating emission time of the light emitting elements; obtaining modification gamma data based on the accumulated emission time; generating digital gamma data based on the accumulated emission time and the modification gamma data; digital-to-analog converting the digital gamma data to generate at least one set of gray voltages; generating data voltages corresponding to input image signals based on the at least one set of gray voltages; and making the light emitting elements emit light based on the data voltages.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 shows a block diagram of an OLED display according to an embodiment of the present invention.

FIG. 2 shows an equivalent circuit diagram of a pixel of an OLED display according to an embodiment of the present invention.

FIG. 3 shows an exemplary sectional view of an OLED and a driving transistor shown in FIG. 2.

FIG. 4 shows a schematic diagram of an OLED according to an embodiment of the present invention.

FIG. 5 shows a block diagram of a signal controller of an OLED display according to an embodiment of the present invention.

FIG. 6 shows a schematic diagram of a lookup table of an OLED display according to an embodiment of the present invention.

FIG. 7 shows a block diagram of an OLED display according to another embodiment of the present invention.

FIG. 8 shows a block diagram of the signal controller and the gray voltage generator of the OLED display shown in FIG. 7.

### DETAILED DESCRIPTION OF THE ILLUSTRATED EMBODIMENTS

In the drawings, the thickness of layers and regions are exaggerated for clarity. Like numerals refer to like elements throughout. It will be understood that when an element such as a layer, region or substrate is referred to as being “on” another element, it can be directly on the other element or intervening elements may also be present. In contrast, when an element is referred to as being “directly on” another element, there are no intervening elements present.

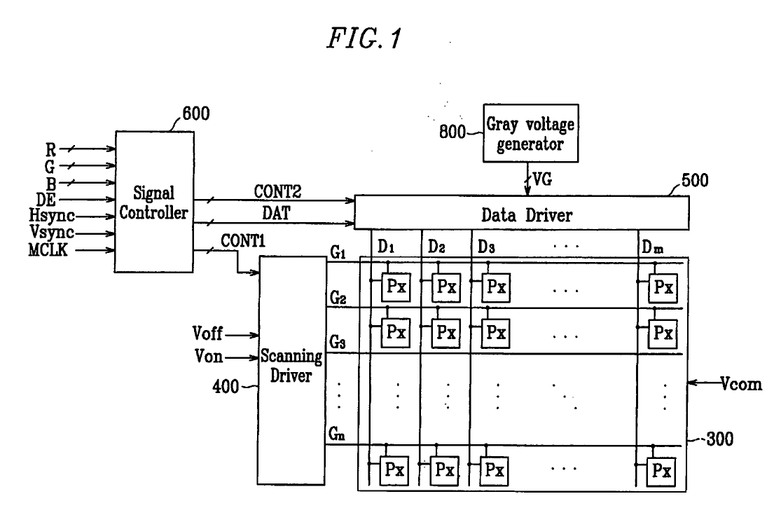

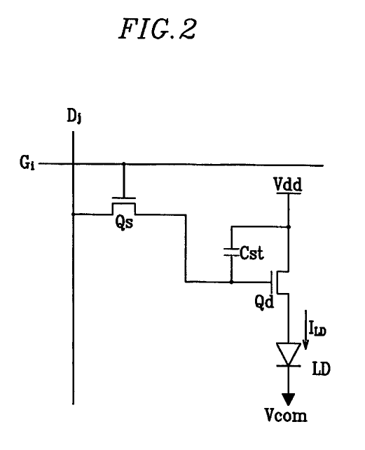

FIG. 1 is a block diagram of an OLED display according to an exemplary embodiment of the present invention. FIG. 2 is an equivalent circuit diagram of a pixel of an OLED display according to an exemplary embodiment of the present invention.

Referring to FIG. 1, an OLED display according to an embodiment includes a display panel 300, a scanning driver 400 and a data driver 500 that are connected to the display panel 300, a gray voltage generator 800 coupled to the data driver 500, and a signal controller 600 that controls the above elements.

The display panel 300 includes a plurality of signal lines and a plurality of pixels PX connected thereto and arranged substantially in a matrix. The signal lines include a plurality of scanning lines G₁-Gₙ transmitting scanning signals and a plurality of data lines D₁-Dₘ transmitting data signals. The scanning lines G₁-Gₙ extend substantially in a row direction and substantially parallel to each other, while the data lines D₁-Dₘ extend substantially in a column direction and substantially parallel to each other.

Referring to FIG. 2, each pixel PX is connected to a scanning line Gᵢ and a data line Dⱼ. Each pixel includes an OLED LD, a driving transistor Qd, a capacitor Cst, and a switching transistor Qs.

The driving transistor Qd has a control terminal connected to the switching transistor Qs, an input terminal connected to a driving voltage Vdd, and an output terminal connected to the OLED LD.

The switching transistor Qs has a control terminal connected to the scanning line Gᵢ, an input terminal connected to the data line Dⱼ, and an output terminal connected to the control terminal of the driving transistor Qd. The switching transistor Qs transmits the data signal applied to the data line Dⱼ to the driving transistor Qd in response to the scanning signal applied to the scanning line Gᵢ.

The capacitor Cst is connected between the control terminal and the input terminal of the driving transistor Qd. The capacitor Cst stores and maintains the data voltage applied to the control terminal of the driving transistor Qd.

The OLED LD has an anode connected to the output terminal of the driving transistor Qd and a cathode connected to a common voltage Vcom. The OLED LD emits light having an intensity depending on an output current I_{LD} of the driving transistor Qd. The output current I_{LD} of the driving transistor Qd depends on the voltage between the control terminal and the output terminal of the driving transistor Qd.

The switching transistor Qs and the driving transistor Qd are n-channel field effect transistors (FETs) including amorphous silicon or polysilicon. However, the transistors Qs and Qd may be p-channel FETs operating in a manner opposite to n-channel FETs.

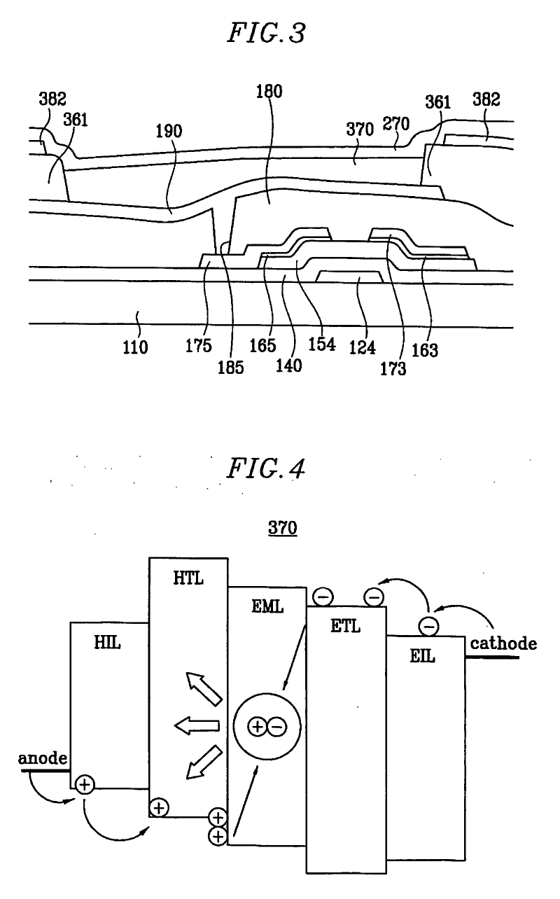

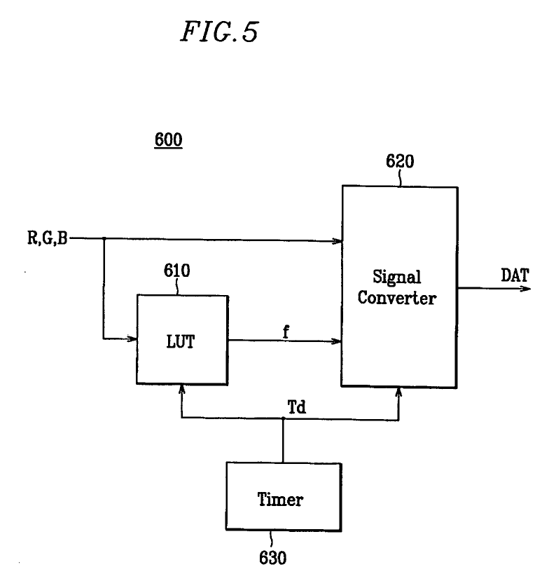

A structure of an OLED LD and a driving transistor Qd connected thereto shown in FIG. 2 will now be described in detail with reference to FIG. 3 and FIG. 4.

FIG. 3 is an exemplary sectional view of an OLED LD and a driving transistor Qd also shown in FIG. 2. FIG. 4 is a schematic diagram of an OLED according to an exemplary embodiment of the present invention.

A control electrode 124 is formed on an insulating substrate 110. The control electrode 124 is preferably made of Al or an Al alloy, Ag or an Ag alloy, Cu or a Cu alloy, Mo a Mo alloy, Cr, Ti, Ta or any combination thereof. The control electrode 124 may have a multi-layered structure including two films having different physical characteristics. One of the two films is preferably made of low resistivity metal including Al, an Al alloy, Ag, an Ag Alloy, Cu, a Cu alloy or any combination thereof for reducing signal delay or voltage drop. The other film is preferably made of material such as Mo, an Mo alloy, Cr, Ta, Ti or any combination thereof that has good physical, chemical, and electrical contact characteristics with other materials such as indium tin oxide (ITO) or indium zinc oxide (IZO). Examples of the combination of the two films are a lower Cr film and an upper Al alloy film and a lower Al alloy film and an upper Mo alloy film. However, the control electrode 124 may be made of other various metals or conductors. The lateral sides of the control electrode 124 are inclined relative to a surface of the substrate, and the inclination angle thereof ranges from about 30 degrees to about 80 degrees.

An insulating layer 140, preferably made of silicon nitride (SiNx), is formed on the control electrode 124.

A semiconductor 154, preferably made of hydrogenated amorphous silicon (abbreviated to “a-Si”) or polysilicon, is formed on the insulating layer 140, A pair of ohmic contacts 163 and 165, preferably made of silicide or n+ hydrogenated a-Si heavily doped with n type impurity such as phosphorous, are formed on the semiconductor 154. The lateral sides of the semiconductor 154 and the ohmic contacts 163 and 165 are inclined relative to the surface of the substrate, and the inclination angles thereof are preferably in a range of from about 30 degrees to about 80 degrees.

An input electrode 173 and an output electrode 175 are formed on the ohmic contacts 163 and 165 and the insulating layer 140. The input electrode 173 and the output electrode 175 are preferably made of refractory metal such as Cr, Mo, Ti, Ta or alloys thereof. The input electrode 173 and the output electrode 175 may have a multilayered structure including a refractory metal film (not shown) and a low resistivity film (not shown). One example of the multi-layered structure is a double-layered structure including a lower Cr/Mo alloy film and an upper Al alloy film. Another example of the multi-layered structure is a triple-layered structure including a lower Mo alloy film, an intermediate Al alloy film, and an upper Mo alloy film. Like the control electrode 124, the input electrode 173 and the output electrode 175 have inclined edge profiles, and the inclination angles thereof range from about 30 degrees to about 80 degrees.

The input electrode 173 and the output electrode 175 are separated from each other and disposed opposite each other with respect to a control electrode 124. The control electrode 124, the input electrode 173, and the output electrode 175 as well as the semiconductor 154 form a TFT serving as a driving transistor Qd having a channel located between the input electrode 173 and the output electrode 175.

The ohmic contacts 163 and 165 are interposed only between the underlying semiconductor stripes 151 and the overlying electrodes 173 and 175 thereon and reduce the contact resistance therebetween. The semiconductor 154 includes an exposed portion, which is not covered by the input electrode 173 and the output electrode 175.

A passivation layer 180 is formed on the electrode 173 and 175, the exposed portion of the semiconductor 154, and the insulating layer 140. The passivation layer 180 is preferably made of inorganic insulator such as silicon nitride or silicon oxide, organic insulator, or low dielectric insulating material. The low dielectric material preferably has a dielectric constant lower than 4.0 and examples thereof are a-Si:C:O and a-Si:O:F formed by plasma enhanced chemical vapor deposition (PECVD). The passivation layer may be photosensitive. The passivation layer 180 may have a flat surface. The passivation layer 180 may have a double-layered structure including a lower inorganic film and an upper organic film to protect the exposed portions of the semiconductor 154. A portion of the output electrode 175 may be exposed through a contact hole 185 in the passivation layer 180.

A pixel electrode 190 is formed on the passivation layer 180. The pixel electrode 190 is physically and electrically connected to the output terminal electrode 175 through the contact hole 185. The pixel electrode 190 is preferably made of a transparent conductor such as ITO or IZO or a reflective metal such as Cr, Ag or Al.

A partition 361 is formed on the passivation layer 180. The partition 361 encloses the pixel electrode 190 to define an opening on the pixel electrode 190. The partition 361 is preferably made of organic or inorganic insulating material.

An organic light emitting member 370 is formed on the pixel electrode 190 and is confined in the opening enclosed by the partition 361.

Referring to FIG. 4, the organic light emitting member 370 has a multilayered structure including an emitting layer EML and auxiliary layers for improving the efficiency of light emission of the emitting layer EML. The auxiliary layers include an electron transport layer ETL and a hole transport layer HTL for improving the balance of the electrons and holes and an electron injecting layer EIL and a hole injecting layer HIL for improving the injection of the electrons and holes. The auxiliary layers may be omitted.

Referring to FIG. 3, an auxiliary electrode 382 is formed on the partition 361. The auxiliary electrode should have a low resistivity and may, for example, be made from an Al alloy.

A common electrode 270 supplied with a common voltage Vcom is formed on the organic light emitting member 370 and the partition 361. The common electrode 270 is preferably made of reflective metal such as Ca, Ba, Cr, Al or Ag, or transparent conductive material such as ITO or IZO.

The auxiliary electrode 382 contacts the common electrode 270 to compensate is the conductivity of the common electrode 270 to prevent the distortion of the voltage of the common electrode 270.

A combination of opaque pixel electrodes 190 and a transparent common electrode 270 is employed in a top emission OLED display that emits light toward the top of the display panel 300, and a combination of transparent pixel electrodes 190 and an opaque common electrode 270 is employed in a bottom emission OLED display that emits light toward the bottom of the display panel 300.

A pixel electrode 190, an organic light emitting member 370, and a common electrode 270 form an OLED LD having the pixel electrode 190 as an anode and the common electrode 270 as a cathode or vice versa. The OLED LD uniquely emits one primary color light depending on the material of the light emitting member 380. One example of a set of primary colors includes red, green, and blue. The display of images is realized by the addition of the three primary colors.

Referring to FIG. 1 again, the gray voltage generator 800 generates a set of gray voltages (or reference gray voltages) related to the luminance of the pixels PX.

The scanning driver 400 is connected to the scanning lines G₁-Gₙ of the display panel 300 and synthesizes a high voltage Von for turning on the switching transistors Qs and a low voltage Voff for turning off the switching transistors Qs to generate scanning signals for application to the scanning lines G₁-Gₙ.

The data driver 500 is connected to the data lines D₁-Dₘ of the display panel 300 and applies data voltages selected from the gray voltages generated by the gray voltage generator 800 to the data lines D₁-Dₘ. However, when the gray voltage generator 800 generates only a few number of gray voltages, i.e., reference gray voltages but not all the gray voltages, the data driver 500 may divide the reference gray voltages to generate a complete set of the gray voltages and selects the data voltages from the complete set of the gray voltages.

The scanning driver 400 and data driver 500 may be implemented as an integrated circuit (IC) chip mounted on the display panel 300 or on a flexible printed circuit (FPC) film in a tape carrier package (TCP) attached to the display panel 300. Alternatively, they may be integrated into the display panel 300 along with the signal lines G₁-Gₙ and D₁-Dₘ and the transistors Qd and Qs.

The signal controller 600 controls the scanning driver 400 and the data driver 500.

The operation of the above-described OLED display will now be described in detail.

The signal controller 600 is supplied with input image signals R, G and B and input control signals controlling the display thereof such as a vertical synchronization signal Vsync, a horizontal synchronization signal Hsync, a main clock MCLK, and a data enable signal DE, from an external graphics controller (not shown). The signal controller 600 generates scanning control signals CONT1 and data control signals CONT2 and processes the image signals R, G and B to make them suitable for the operation of the display panel 300 using the input control signals and the input image signals R, G and B. The signal controller 600 sends the scanning control signals CONT1 to the scanning driver 400 and sends the processed image signals DAT and the data control signals CONT2 to the data driver 500. The signal controller 600 modifies the image signals R, G and B based on accumulated driving time of the driving transistors Qd.

The scanning control signals CONT1 include a scanning start signal STV for instructing the scanning driver to start scanning and at least one clock signal for to control the output time of the high voltage Von. The scanning control signals CONT1 may include a plurality of output enabling signals for defining the duration of the high voltage Von.

The data control signals CONT2 include a horizontal synchronization start signal STH to signal the start of data transmission to a group of pixels PX, a load signal LOAD for instructing to apply the data voltages to the data lines D₁-Dₘ, and a data clock signal HCLK.

The data driver 500 receives the data control signals CONT2, including a packet of image data for a group of pixels, from the signal controller 600 then converts the image data into analog data signals, and applies the data signals to the data lines D₁-Dₘ.

The scanning driver 400 applies the high voltage Von to the scanning line G₁-Gₙ in response to the scan control signals CONT1 from the signal controller 600, to turn on the switching transistors Qs. The data signals applied to the data lines D₁-Dₘ are supplied to the control terminals of the driving transistor Qd and the capacitors Cst through the activated switching transistors Qs. The capacitors Cst store the data signals. The voltages of the capacitors Cst are maintained to maintain the voltages between the control terminals and the output terminals of the driving transistors Qd after the switching transistors Qs are turned off.

The driving transistor Qd puts out an output current I_{LD} having a magnitude dependant on the data signals. The intensity of the light emitted by the OLED LD depends on the output current I_{LD}. The change in the intensity of light results in the display of images.

By repeating this procedure by a unit of a horizontal period (also referred to as “1H” and equal to one period of the horizontal synchronization signal Hsync and the data enable signal DE), all scanning lines G₁-Gₙ are sequentially supplied with the high voltage Von during a frame (or a vertical period), thereby applying the data voltages to all pixels.

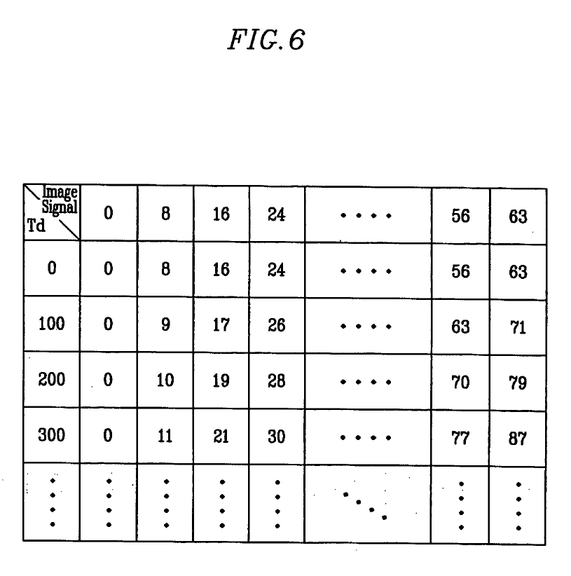

The modification of the image signals by a signal controller according to an embodiment of the present invention will now be described in detail with reference to FIG. 5 and FIG. 6.

FIG. 5 is a block diagram of a signal controller of an OLED display shown in FIG. 1 according to an embodiment of the present invention. FIG. 6 is a schematic diagram of a lookup table of the signal controller shown in FIG. 5 according to an embodiment of the present invention.

Referring to FIG. 5, a signal controller 600 according to an embodiment of the present invention includes a lookup table 610, a signal converter 620, and a timer 630.

The timer 630 generates an accumulated driving time data Td, which relays the accumulated time that an OLED LD has emitted light after an OLED display is turned on. The accumulated driving time data Td is accumulated over the entire lifetime of the pixels. The timer 630 also supplies the time data Td to the lookup table 610 and the signal converter 620.

The lookup table 610 receives input image signals R, G and B and the time data Td and extracts a reference modification data f for obtaining modified image signals. The lookup table 610 then outputs the extracted reference modification data f to the signal converter 620.

It requires space and time for all of the modified image signals for all of the accumulated driving time data Td and all of the image signals to be obtained and stored in the lookup table 610. Reference modification data f for some of the time data Td and some of the image signals are stored into the lookup table 610. The modified image signals for other time data Td and other image signals are calculated by interpolating four reference modification data f stored in the lookup table 610 to determine the adjacent time data Td and adjacent image signals.

The lookup table 610 is represented as a matrix in FIG. 6. The leftmost column indicates the accumulated driving time data Td in units of 100 hours. The uppermost row indicates image signals in unit of eight grays among total 64 grays. The reference modification data f are stored at the intersections of the time data Td and the image signals R, G and B. A reference modification data f for an input image signal R, G and B and a time data Td is a modified image signal that can yield a target luminance or a target current I_{LD} for the input image signal R, G and B. A reference modification data is obtained by considering the shift of the threshold voltage Vth of the driving transistor Qd at the accumulated driving time. For example, if the time data Td indicate that the accumulated driving time is equal to 300 hours and the input image signal R, G and B represents the 24-th gray, which is written as (300, 24), then the corresponding reference modification data f is equal to “30.” The reference modification data f may be obtained by experiments.

The lookup table 610 supplies four reference modification data f related to the input image signal R, G and B and the time data Td to the signal converter 620. For example, referring to FIG. 6, when the accumulated driving time is equal to 250 hours and the input image signal represents the 20-th gray, the four reference modification data f related thereto are the reference modification data f for (200, 16), (200, 24), (300, 16), and (300, 24).

The signal converter 620 generates a modified image signal DAT by interpolation based on the input image signal R, G and B, the accumulated driving time data Td from the timer 630, and the four reference modification data f from the lookup table 610. Then, the signal converter 620 outputs the modified image signals DAT to the data driver 500. One example of the interpolation is linear interpolation.

Reference modification data for respective colors may be independently stored in the lookup table 610. The modification is independently performed for respective colors. This compensates for the different efficiencies of different-color OLEDs so that the different-color OLEDs may represent the same luminance for the same gray.

The modified image signals are generated by interpolation based on the reference modification data f that are stored in the lookup table 610. The modified image signals reflect the accumulated driving time. Accordingly, the driving transistor Qd can produce the currents causing the target luminance for the input image signals R, G and B regardless of the change of the threshold voltage Vth of the driving transistor Qd.

The amount of data stored in the lookup table 610 can be varied. The data stored in the lookup table 610 may be arranged in irregular intervals. The bit number of the image signals can also be varied, for example to eight bits (i.e., 256 grays) or ten bits (i.e., 1024 grays).

The present invention may also be applicable to a current programming type OLED display that uses currents rather than voltages as data signals.

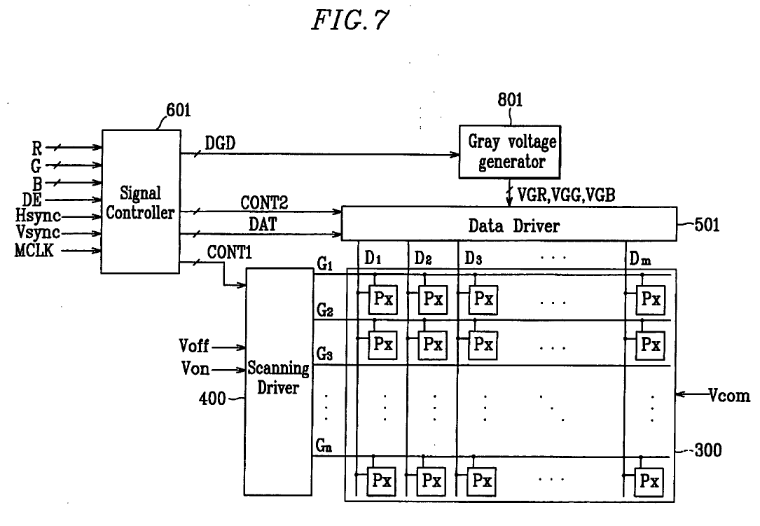

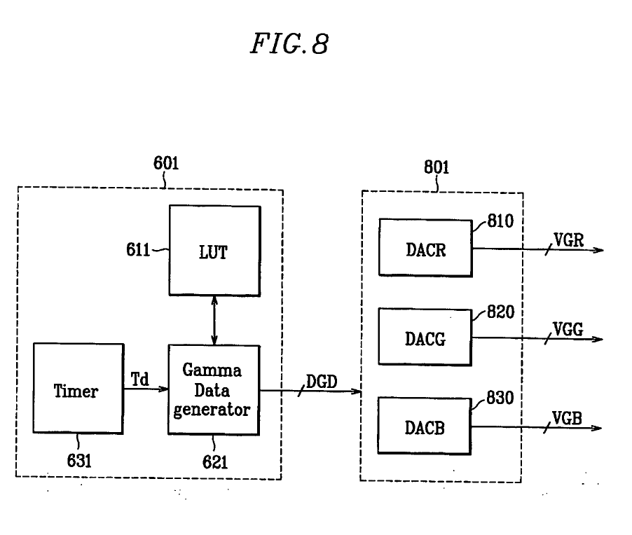

Referring to FIG. 7 and FIG. 8, an organic light emitting diode (OLED) display according to another exemplary embodiment of the present invention will now be described in detail.

FIG. 7 is a block diagram of an OLED display according to an exemplary embodiment of the present invention. FIG. 8 is a block diagram of a signal controller and a gray voltage generator of an OLED display shown in FIG. 7.

Referring to FIG. 7, an OLED display includes a display panel 300, a scanning driver 400 and a data driver 501 connected to the display panel 300, a gray voltage generator 801 coupled to the data driver 501, and a signal controller 601 controlling the above elements.

The display panel 300 includes a plurality of signal lines G₁-Gₙ and D₁-Dₘ and a plurality of pixels PX connected thereto and arranged substantially in a matrix.

Since the configurations of the display panel 300 and the scanning driver 400 are substantially the same as those shown in FIG. 1, the detailed description thereof will be omitted.

The signal controller 601 controls the scanning driver 400, the data driver 501, etc., and generates digital gamma data DGD to be supplied to the gray voltage generator 801.

The gray voltage generator 801 generates three sets of reference gray voltages VGR, VGG and VGB related to the luminance of the pixels PX based on the digital gamma data DGD supplied from the signal controller 601. The three sets of reference gray voltages VGR, VGG and VGB are supplied to respective pixels emitting three primary colors such as red, green and blue (referred to as red, green, and blue pixels hereinafter). The gray voltage generator 801 may generate only one set of gray voltages, or may generate four or more sets of gray voltages corresponding to four or more primary colors.

The data driver 501 is connected to the data lines D₁-Dₘ of the display panel 300. The data driver 501 divides each of the reference gray voltages VGR, VGG and VGB from the gray voltage generator 801 to generate a complete set of the gray voltages for each color and selects the data voltages corresponding to the image data DAT from the complete set of the gray voltages. The data driver 501 applies the selected data voltages to the data lines D₁-Dₘ.

The signal controller 601 and the gray voltage generator 801 can compensate the shift of the driving transistors Qd and the degradation of the images for each color. The signal controller 601 and the gray voltage generator 801 will now be described in detail with reference to FIG. 8.

Referring to FIG. 8, the signal controller 601 includes a lookup table 611, a gamma data generator 621, and the timer 631.

The timer 631 generates an accumulated driving time data Td, which relays the accumulated time that an OLED LD has emitted light after an OLED display is turned on. The accumulated driving time data Td is accumulated over the entire lifetime of the pixels. The timer 631 also supplies the time data Td to the gamma data generator 621.

The lookup table 611 stores reference gamma modification data as a function of time for each color to obtain modified image signals. The reference gamma modification data for a given color and a given time correspond to a set of modified gray voltages that can yield a target luminance or a target current I_{LD} for the given color. The reference gamma modification data is obtained by considering the shift of the threshold voltage Vth of the driving transistor Qd at the given time. The reference gamma modification data may be obtained by experiments.

The gamma data generator 621 reads the reference gamma modification data corresponding to the accumulated driving time data Td from the lookup table 611 and processes the reference gamma modification data to generate the digital gamma data DGD.

It requires space and time for all of the digital gamma data DGD for all of the accumulated driving time data Td and all of the image signals to be obtained and stored in the lookup table 611. Digital gamma data DGD for some of the time data Td are stored as the reference gamma modification data into the lookup table 610. The digital gamma data DGD for other time data Td are calculated by interpolating the reference gamma modification data stored in the lookup table 611 for adjacent time data Td.

According to another embodiment of the present invention, an elapsed time and an optimal gamma data corresponding to the elapsed time for every fixed amount of luminance variation due to the time elapse are obtained and stored in the lookup table 611. The gamma data may be extracted based on the accumulated driving time data Td and the elapsed time to generate the digital gamma data DGD.

The gray voltage generator 801 includes red, green, and blue digital-analog converters 810, 820 and 830. Each of the red, green, and blue digital-analog converters 810, 820 and 830 converts the digital gamma data DGD into a set of reference gray voltages VGR, VGG or VGB for a corresponding color to be supplied to the data driver 501. The gray voltage generator 801 may include a register for storing the digital gamma data DGD. The digital-analog converters 810, 820 and 830 may be implemented in various forms, and the number of the digital-analog converters 810, 820 and 830 may be reduced by employing sampling-holding circuits (not shown).

In this way, a gamma curve for each color and for the elapsed time can be generated such that the luminance of the pixels can be uniform regardless of the color even though the threshold voltages of the driving transistors Qd shift or the efficiency of the OLED LD is varied.

The gray voltage generator 801 may generate all of the gray voltages. In this case, the data driver 501 need not include a voltage divider circuit and merely selects the gray voltages corresponding to the image data DAT.

Alternatively, the gray voltage generator 801 may generate only one set of reference gray voltages.

The OLED display shown in FIG. 7 and FIG. 8 operates similarly to that shown in FIG. 1, FIG. 2, FIG. 3, FIG. 4, FIG. 5, and FIG. 6. The features of the OLED display shown in FIG. 1, FIG. 2, FIG. 3, FIG. 4, FIG. 5, and FIG. 6 can be applied to the OLED display shown in FIG. 7 and FIG. 8.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A display device, comprising:
a plurality of pixels, each pixel including a light emitting element;
a signal controller that modifies input image signals based on an accumulated time of driving the light emitting elements; and
a data driver that generates data signals based on the modified image signals and supplies the data signals to the pixels.

2. The display device of claim 1,
wherein the signal controller comprises a lookup table that stores modification data as a function of the accumulated time.

3. The display device of claim 2,
wherein the signal controller further comprises a signal converter that converts the input image signals into modified signals based on the modification data.

4. The display device of claim 3,
wherein the signal controller further comprises a timer that measures the accumulated time and supplies a time data that conveys the accumulated time to the signal converter.

5. The display device of claim 4,
wherein the pixels emit light of a plurality of colors; and
wherein the lookup table stores the modification data for each color.

6. The display device of claim 5,
wherein the signal converter converts the input image signals into the modified signals based on the modification data for each color.

7. The display device of claim 2,
wherein the modification data vary depending on the input image signals.

8. The display device of claim 7,
wherein the lookup table stores the modification data for a first predetermined number of the accumulated time and a second predetermined number of the input image signals.

9. The display device of claim 8,
wherein the signal controller obtains the modified image signals by interpolating the modification data.

10. The display device of claim 1,
wherein each of the pixels further comprises a driving transistor that supplies a current to the light emitting element for emitting light; and
a switching transistor that selectively transmits the data signals to the driving transistor.

11. The display device of claim 10,
wherein the driving transistor comprises amorphous silicon.

12. The display device of claim 10,
wherein each of the pixels further comprises a capacitor that stores the data signals.

13. A method of driving a display device including light emitting elements, comprising:
accumulating emission time of the light emitting elements;
obtaining modification data for input image signals based on the accumulated emission time;
modifying the input image signals based on the modification data; and
making the light emitting elements emit light based on the modified image signals.

14. The method of claim 13,
wherein the obtainment of modification data for input image signals comprises:
storing modification data into a lookup table as a function of emission time and image signals; and
extracting the modification data from the lookup table based on the accumulated emission time and the input image signals.

15. The method of claim 14,
wherein the lookup table stores the modification data for a first predetermined number of the emission time and a second predetermined number of the image signals.

16. The method of claim 15,
wherein the modification of the input image signals comprises interpolating the extracted modification data.

17. The method of claim 14,
wherein the modification data comprises a plurality of reference modification data for a plurality of colors.

18. The method of claim 17,
wherein the modification of the input image signals comprises modifying the input image signals for each color.

19. A display device, comprising:
a plurality of pixels, each pixel including a light emitting element;
a signal controller that generates digital gamma data based on an accumulated time of driving the light emitting elements;
a gray voltage generator that generates at least one set of gray voltages corresponding to the digital gamma data supplied from the signal controller; and
a data driver that generates data voltages corresponding to input image signals based on the at least one set of gray voltages supplied from the gray voltage generator and supplies the data signals to the pixels.

20. The display device of claim 19,
wherein the signal controller comprises a lookup table that stores modification gamma data as a function of the accumulated time.

21. The display device of claim 20,
wherein the signal controller further comprises a timer that measures the accumulated time and generates a time data to convey the accumulated time.

22. The display device of claim 21,
wherein the signal controller further comprises a gamma data generator that generates the digital gamma data based on the time data supplied from the timer and based on the modification data supplied from the lookup table.

23. The display device of claim 19,
wherein the gray voltage generator comprises a digital-analog converter that converts the digital gamma data into the at least one set of gray voltages.

24. The display device of claim 23,
wherein the gray voltage generator further comprises a register that stores the digital gamma data.

25. The display device of claim 23,
wherein the at least one set of gray voltages comprises three sets of gray voltages representing different colors.

26. The display device of claim 23,
wherein the data driver divides the at least one set of gray voltages to generate the data voltages.

27. The display device of claim 19,
wherein each of the pixels further comprises a driving transistor that supplies a current to the light emitting element for emitting light; and
a switching transistor that selectively transmits the data voltages to the driving transistor.

28. The display device of claim 27,
wherein the driving transistor comprises amorphous silicon.

29. The display device of claim 27,
wherein each of the pixels further comprises a capacitor that stores the data voltages.

30. A method of driving a display device including light emitting elements, comprising:
accumulating emission time of the light emitting elements;
obtaining modification gamma data based on the accumulated emission time;
generating digital gamma data based on the accumulated emission time and the modification gamma data;
converting the digital gamma data from digital-to-analog to generate at least one set of gray voltages;
generating data voltages corresponding to input image signals based on the at least one set of gray voltages; and
making the light emitting elements emit light based on the data voltages.

31. The method of claim 30,
wherein the obtainment of modification gamma data comprises:
storing modification gamma data in a lookup table as function of emission time; and
extracting the modification gamma data from the lookup table based on the accumulated emission time.

32. The method of claim 31,
wherein the modification gamma data comprises a plurality of reference modification gamma data for a plurality of colors.

33. The method of claim 32,
wherein the generation of data voltages comprises:
dividing the gray voltages; and
generating the data voltages by selecting the divided gray voltages.
